(19) United States
(12) Patent Application Publication
(10) Pub. No.: US 2002/0147687 A1
(43) Pub. Date: Oct. 10, 2002

(54) Method and computer system for program recording service

(75) Inventors: Gerd Breiter, Wildberg (DE); Thomas Schaeck, Achern (DE)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 10/116,357

(22) Filed: Apr. 4, 2002

(30) Foreign Application Priority Data
Apr. 6, 2001 (EP) 01108694.9

(51) Int. Cl. G06F 17/60

(52) U.S. Cl. 705/51

(57) ABSTRACT

A server computer has a recorder component for recording of programs transmitted to the server from a variety of sources, such as television station, cable radio and Internet radio. The recorder component can be programmed from a remote location of a client through the Internet. A corresponding file containing the recorded program is streamed from a streaming component to a media player.

### FIELD OF THE INVENTION

The present invention relates to the field of recording, and in particular to the programming of a recording device from a remote location and the delivery of a recorded program to a remote user.

### BACKGROUND OF THE INVENTION

Patent document DE 19743367 A1 discloses a system for remote programming of a video recorder. The system allows the programming of a video recorder by a user at a remote location. The programming is accomplished by establishing a telecommunications link with the video recorder and by inputting program commands using natural speech. For this purpose the video recorder contains a speech recognition unit. A similar method and system for remotely programming a video recorder is disclosed in patent document DE 19615437 C1.

A common disadvantage of the prior art methods and systems for remote recording is a lack of flexibility. Firstly, the user requires a dedicated device which is capable of being programmed remotely. Secondly, the dedicated device has access to a limited number of programs and is restricted to a specific type of media. Thirdly, there is no convenient user interface for selecting a program to be recorded.

A most important disadvantage is that the user can only access the recorded video after having returned home. It is not possible with such prior art methods and systems to provide the recorded program to the remote user; rather the user has to physically access the video recording media.

### SUMMARY OF THE INVENTION

The invention is an improved method and system for remotely recording of media programs.

The invention utilizes a server computer having a recording component for remotely programming the recording of a desired program and for delivering the recorded program to a remote user. The recorder component of the server computer can be coupled to a variety of sources, such as TV stations, cable radio stations, conventional radio stations, internet radio stations and the like. A user can access the server through a computer network, such as the Internet, to select a program to be recorded at a later time.

In a preferred embodiment the recorded program is delivered to a remote user using streaming technology. This has the advantage of minimizing any delays (latency) the user experiences when starting the delivery. However it is also possible to deliver the recorded content to the end user with normal file transfer mechanisms for rendering on his device. In a further preferred embodiment a user interacts with the server through the intermediary of a Web portal. The server thereby provides its services to the Web portal through a well defined Web services Interface. For example the Web portal can filter out advertisements contained in the recorded data.

In a further preferred embodiment user profiles are stored on the server or the Web portal for generation of a list of programs suggested to a user for recording.

In a further preferred embodiment a key is provided for each recorded program such that a user can access the recorded program from a remote location by identifying the recorded program file by means of the key. The user can also provide the key to another user such that the other user can also access the recorded program.

It is a particular advantage of the present invention that the device for programming the recording does not need to be the same device as the device on which the recorded program is delivered at a later point of time. This allows, for example, a personal computer to be used to specify the program to be recorded for later playback through a wireless device.

### BRIEF DESCRIPTION OF THE DRAWINGS

The invention will now be explained in greater detail with respect to the drawings in which:

FIG. 1 is a block diagram showing a first embodiment of the computer system of the invention,

FIG. 2 is a second embodiment of a computer system of the invention,

FIG. 3 is a flow chart of a method for programming a recorder component on a server, and

FIG. 4 is a method for rendering of a program which has been previously recorded.

### DETAILED DESCRIPTION

The following terms and acronyms are used throughout the detailed description:

Client-Server.

A model of interaction in a distributed system in which a program at one site sends a request to a program at another site and waits for a response. The requesting program is called the “client”, and the program which responds to the request is called the “server”. In the context of the World Wide Web (discussed below), the client is a “Web browser” (or simply “browser”) which runs on a computer of a user; the program which responds to browser requests by serving Web pages is commonly referred to as a “Web server”.

Hyperlink. A navigational link from one document to another, or from one portion (or component) of a document to another. Typically, a hyperlink is displayed as a highlighted word or phrase that can be selected by clicking on it using a mouse to jump to the associated document or documented portion.

Hypertext System. A computer-based informational system in which documents (and possibly other types of data entities) are linked together via hyperlinks to form a user-navigable “web”.

Internet.

A collection of interconnected (public and/or private) networks that are linked together by a set of standard protocols (such as TCP/IP and HTTP) to form a global, distributed network.

World Wide Web (“Web”).

Generally refers to both (i) a distributed collection of interlinked, user viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML.

Web Site.

A computer system that serves informational content over a network using the standard protocols of the World Wide Web. Typically, a Web site corresponds to a particular Internet domain name, such as “IBM.com”, and includes the content associated with a particular organisation. As used herein, the term is generally intended to encompass both (i) the hardware/software server components that serve the informational content over the network, and (ii) the “back end” hardware/software components, including any non-standard or specialised components, that interact with the server components to perform services for Web site users.

HTML (Hyper Text Markup Language).

A standard coding convention and set of codes for attaching presentation and linking attributes to informational content within documents. (HTML 2.0 is currently the primary standard used for generating Web documents.) During a document authoring stage, the HTML codes (referred to as “tags”) are embedded within the informational content of the document. When the Web document (or HTML document) is subsequently transferred from Web server to a browser, the codes are interpreted by the browser and used to parse and display the document. Additionally in specifying how the Web browser is to display the document, HTML tags can be used to create links to other Web documents (commonly referred to as “hyperlinks”). For more information on HTML, see Ian S. Graham, The HTML Source Book, John Wiley and Sons, Inc. 1995 (ISBN 0471-11894-4).

HTTP (Hyper Text Transport Protocol).

The standard World Wide Web client-server protocol used for the exchange of information (such as HTML documents, and client requests for such documents) between a browser and a Web server. HTTP includes a number of different types of messages that can be sent from the client to the server to request different types of server actions. For example, a “GET” message, which has the format GET <URL>, causes the server to return the document in a file located at the specified URL.

JAVA.

A portable language for building highly distributable applications or applets. An applet can be accessed over the Internet. It is self-contained in that it carries its' own presentation and processing code and can run on whatever type of computer which imports it. Applets are being used as “plug-in” units that form part of a larger application.

URL (Uniform Resource Locator).

A unique address which fully specifies the location of a file or other resource on the Internet. The general format of a URL is protocol://machine address:port/path/filename. The port specification is optional. If none is entered by the user, the browser defaults to the standard port for whatever service is specified as the protocol.

Cookies.

A technology that enables a Web server to retrieve information from a user's computer that reveals prior browsing activities of the user. The informational item stored on the user's computer (typically on the hard drive) is commonly referred to as a “cookie”. Many standard Web browsers support the use of cookies.

SOAP.

An open standards-based interoperability protocol that uses XML (Extensible Markup Language) to provide a common messaging format to link together applications and services anywhere on the Internet regardless of operating system, object model or programming language.

UDDI (Universal Description, Discovery and Integration).

A platform-independent open framework for describing services, discovering businesses and integrating business services using the Internet. The UDDI standard takes advantage of standards such as Extensible Markup Language (XML), and HTTP and Domain Name Systems (DNS) protocols. Additionally, cross platform programming features are addressed by adopting the SOAP messaging specifications.

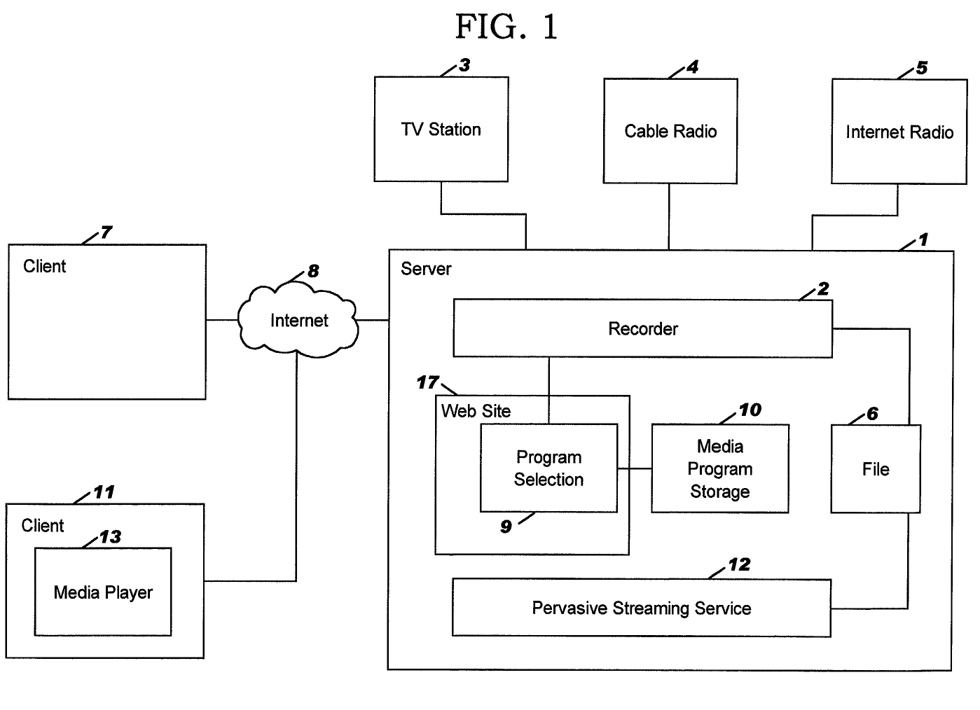

FIG. 1 shows a computer system having a server computer including a recorder component 2 which can be coupled to a number of media sources, such as TV station 3, cable radio 4 and Internet radio 5. When the recorder component 2 is invoked it records a specified program transmission provided by one of the sources and produces a corresponding data file 6.

A plurality of users (user 1, user 2, user 3, . . . , user n) can connect to the server computer 1 via the Internet 8. The users can use a variety of client devices, such as home personal computers, business computers, mobile computers, mobile phones, personal digital assistants (PDAs) or other mobile computing and/or communication devices.

A client 7 using one of the devices mentioned above can access a Web site 17 on server 1 through Internet 8 by inputting a corresponding URL into its Internet browser program. The Web site 17 will take care that the web pages presented to interact with the client will always have the form which is most suitable to fit the client's actual device capabilities. After the user is authenticated he can select media programs to record or can receive previously recorded programs. When the user wants to record programs he gets program selection page(s) 9. These Web page(s) 9 are associated with a Media Program Storage component 10 containing a data base of the available programs from sources such as TV station 3, cable radio 4 and internet radio 5. The Media Program Storage component 10 is regularly updated by the server 1 to reflect program changes and to load program schedules as they become available.

The program selection Web page(s) 9 present the client 7 with a list of available programs for selection. The selection of a particular program is used by the client 7 to correspondingly program the recorder component. The Recorder Component 2 then records each selected item, which means saving it as file 6. Each recorded file will be identified by a unique key.

After the recording occurs, the same or a different client 11 connects to the Web site 17 via the Internet 8 to initiate the playback of the previously recorded program. After authentication, a client can choose to record media programs or receive already recorded programs.

A client who elects to receive previously recorded programs views Web page(s) which show him the list of his recorded content. From this list he can select the items he wants to be rendered. The rendering is preferably performed by server 1 by means of a streaming operation through a pervasive streaming service 12.

For this purpose the streaming component 12 of the server 1 interacts with media player 13 at client 11 in order to stream the file 6 to the media player 13. Based on the type of media player, the pervasive streaming service selects the most suitable stream server component for that specific media player and client type. This could result in an “on the fly conversion” of the media to be streamed, to fit the specific needs of the client's media player.

One suitable technology for the streaming is the IBM Video charger—as one specific stream server used by the pervasive streaming service 12—and the IBM video charger player—as far as the media player 13 is concerned. This is of course only one example. There are a variety of media streamer/players for different devices (PDA's etc.) available and the pervasive streaming service 12 will always select the one which is best suited to the client's media player.

Depending on the capabilities of the rendering device, the quality of the streamed media will be dynamically adjusted.

The pervasive streaming service could, of course, also support live feeds from specified sources, which means that as an example the kids in the backseat of a car could decide to watch live TV program through that interface.

The fee for the service could be staged through different classes of service requested by the user and be based on the size of content the user wants to record and keep.

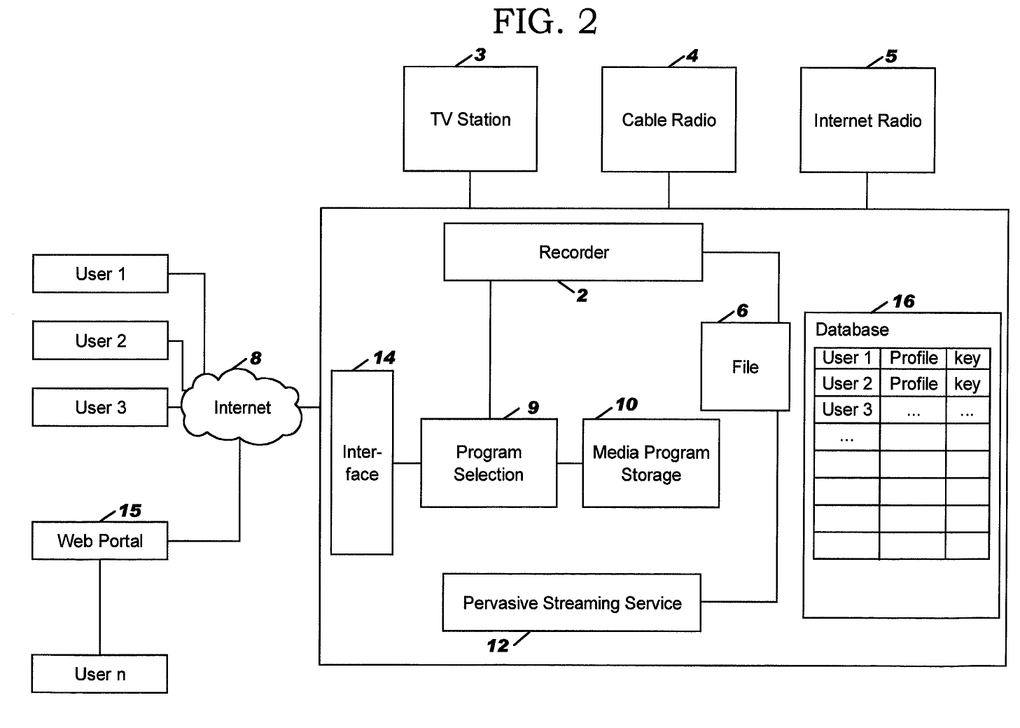

FIG. 2 shows a further preferred embodiment of the invention in which like elements are denoted with the same reference numerals as in the embodiment of FIG. 1. The key component within this embodiment is the Web Interface component 14. This component 14 provides a platform independent universal interface to provide the services offered by server 1 as distributed Web services. The interface 14 can be based on the SOAP/UDDI standards.

These sets of recording and streaming services include the same functionality as described above. There are services to register and deregister an user, to search and select available programs, program the recording component based on that selection, select recorded programs for a specific user and finally get this content streamed or transmitted to be rendered at the client.

Further the server 1 contains a database 16. Database 16 contains an entry for each of the users. When a user registers with the server 1 a user profile is created and stored in the database 16.

The user always will interact with the services offered by the Interface 14 through means of a program, e.g. a Web Application. A popular example of such a Web Application is a Web portal. End user n connects to Web portal 15. Web portal 15 serves as an intermediary between the end user n and the Web services provided by the server computer 1.

The users interact with the portal to request services from server 1. When a user 1 selects a particular program for recording this way, the portal calls the appropriate Web Service through the Interface 14. A key is assigned to this selection and stored in the database 16. The key is returned to the program requesting the service. In the example with the portal, this portal will store the key together with the other information about the recorded program (Title, date, time etc.).

When the user requests the rendering of a selected program from the portal at a later point in time, the portal calls the appropriate Web Service of the Server 1 through the Interface component 14 and passes the User Information and the key identifying the object to be rendered to the server 1 in order to invoke the streaming of the recorded file being identified with by the key.

If more than one user requests the recording of the same program, the program will be recorded only once; different keys can still be assigned to the same file 6 to keep the respective keys private to the users.

The user can pass this key to another user, for example, via e-mail. This enables the other user to request the streaming of the object identified by the key to his client.

A user could also upload a file for storage on the server and gets a corresponding key for the uploaded file. The user can provide this key to another user such that the other user can access the file (which means request the streaming of the file to his client system) which has been uploaded.

According to a further preferred embodiment the server computer 1 can filter out certain data out of the file 6 or embed additional data into the original data when streaming the file to the client. The filter can be content sensitive, for example to filter out advertisements or other undesired content.

On the other hand it could embed content into the stream, for example to add advertisements to the stream. It may be necessary for the user to provide compensation to the Web portal 15 or the server 1 for such an additional service or get lower fees for accessing the service if he accepts to get advertisements ingested.

The streaming component 12 can select the data format and the data rate and/or the quality of the streamed data in accordance with the capabilities of a corresponding media player which is used at the client site.

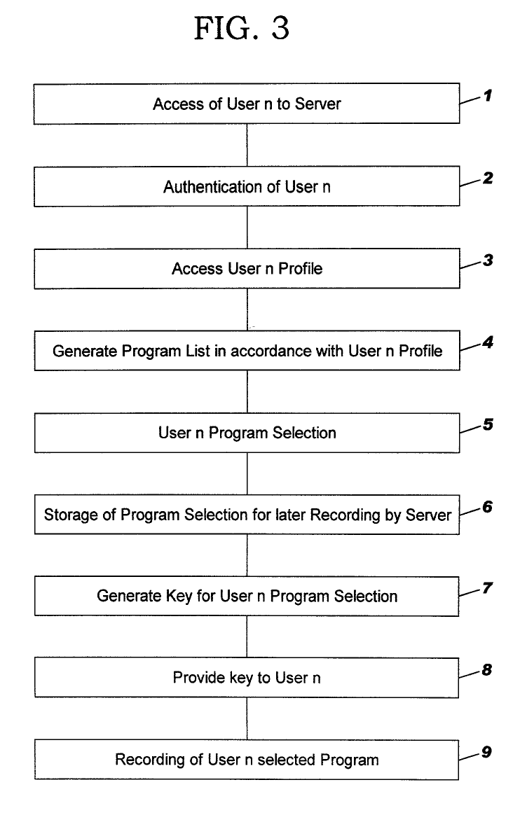

FIG. 3 is a flow chart depicting an embodiment of the method of the invention for programming the recording of a desired program. In step 1 the user connects to the server. In step 2 the user authenticates himself. This can be done by entering his user ID and his password, or with the help of stored cookies or with certificates or any other authentication mechanism.

In step 3 the user profile is accessed by the server based on the user ID. The user profile contains a history of past program selections of the user and corresponding subjects of interest to the user. Based on this user profile a selection of program is generated and listed in step 4 such that the user can select from the generated list of programs in step 5.

The program selection of step 5 is stored on the server for purposes of recording of the selected program. The program selection serves to program the recorder component of the server such that a corresponding file containing the recorded program is generated by the recorder component.

In step 7 a key is generated for the selected program. The key is associated with the file to capture the recorded program and is provided to the user in step 8. In step 9 the user-selected program is actually recorded by the recorder component of the server and the corresponding data is stored in the file associated with the key.

The user can use the key for its own access to the recorded program or he can provide the key to another user.

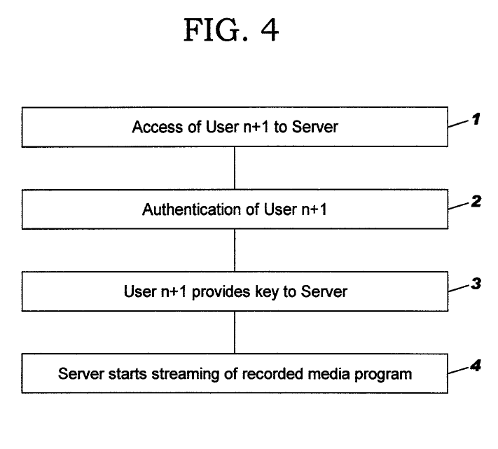

FIG. 4 shows the steps performed by a user n+1 for accessing a program which was recorded at the direction of a first user n from whom the user n+1 received the key. In step 1 the user n+1 connects to the server. For the authentication of user n+1 in step 2 there are a variety of options:

the user n+1 just enters the key provided by the first user; the correct key is sufficient to obtain access permission;

the user n+1 enters the key and the user ID of the first user which in combination is a sufficient to obtain access permission;

the user n+1 has to be a registered user having its own user ID and needs to have access permission to the file identified by the key. Thus,

the user n+1 needs to enter its own user ID in addition to the key and/or the user ID of the first user.

In step 3 the user n+1 provides the key to the server such that the server initiates the streaming of the file identified by the key and/or the combination of the key and a user ID.

In step 4 the streaming of the recorded program is started by the streaming component of the server and the respective media player of the client device.

What is claimed is:

1. A method for programming a recorder component of a server by a client comprising the steps of:
inputting of a program selection to be recorded into the server by the client,
coupling the recorder component to a source providing a broadcast of the selected program, and
recording of the selected program.

2. The method of claim 1 further comprising the steps of:
authenticating a user of the client,
accessing a user profile based on the authentication,
providing the user with a user profile specific program list for selection of a program for recording.

3. The method of claim 1 further comprising the steps of:
generating a key for a user's program selection,
providing the key to the user for later access to the recorded program.

4. The method of claim 3 whereby a plurality of users select the same program for recording and the program is recorded only once for later access of the plurality of users.

5. The method of any of claims 1-4 wherein the user provides a server generated key to another user for enabling the other user's access to the recorded program.

6. The method of claim 5 wherein the user provides the key to the other user by means of an electronic transmission.
